(19) United States
(12) Patent Application Publication
(10) Pub. No.: US 2023/0341680 A1
(43) Pub. Date: Oct. 26, 2023

(54) APPARATUS FOR GENERATING A VIRTUAL IMAGE, COMPRISING AN ADJUSTMENT MECHANISM FOR ANTIREFLECTIVE SLATS

(71) Applicant: Continental Automotive Technologies GmbH, (US)

(72) Inventors: Felicitas Wille, Darmstadt (DE); Klaus Seifert, Darmstadt (DE)

(73) Assignee: Continental Automotive Technologies GmbH, Hannover (DE)

(21) Appl. No.: 18/026,767

(22) PCT Filed: Aug. 12, 2021
(86) PCT No.: PCT/DE2021/200109

§ 371 Date: Mar. 16, 2023

(30) Foreign Application Priority Data
Sep. 17, 2020 (DE) 10 2020 211 662.8

(51) Int. Cl. G02B 27/01; G02B 27/00

(52) U.S. Cl. CPC G02B 27/0101; G02B 27/0081; G02B 2027/0123

(57) ABSTRACT

A device for generating a virtual image comprising a display element for generating an image, an optical waveguide for expanding an exit pupil and an anti-glare element arranged downstream of the optical waveguide in the beam path, wherein the anti-glare element is a shutter which has a plurality of slats wherein the slats come to rest in each case on a slant of at least one one-piece spring is disclosed.

### CROSS REFERENCE TO RELATED APPLICATIONS

This U.S. patent application claims the benefit of PCT patent application No. PCT/DE2021/200109, filed Aug. 12, 2021, which claims the benefit of German patent application No. 10 2020 211 662.8, filed Sep. 17, 2020, both of which are hereby incorporated by reference.

### TECHNICAL FIELD

The present disclosure relates to an adjustment mechanism for anti-reflective slats of a display apparatus having a picture generating unit with a display element for displaying an image and an optical unit for projecting the image onto a projection surface.

Such display apparatuses may, for example, be used for a head-up display for a means of transportation. A head-up display, also referred to as a HUD, is intended to mean a display system in which the viewer may maintain their viewing direction since the contents to be represented are superposed into their visual field. While such systems were originally used primarily in the aerospace sector due to their complexity and costs, they are now also being used in large-scale production in the automotive sector.

### BACKGROUND

Head-up displays generally consist of an image generator, an optical unit, and a mirror unit. The image generator produces the image. The optical unit directs the image onto the mirror unit. The image generator is often also referred to as a picture generating unit or PGU. The mirror unit is a partially reflecting, light-transmissive pane. The viewer thus sees the contents represented by the image generator as a virtual image and at the same time sees the real world behind the pane. In the automotive sector, the windshield is often used as mirror unit, and the curved shape of the windshield must be taken into account in the representation. Due to the interaction of the optical unit and the mirror unit, the virtual image is an enlarged representation of the image produced by the image generator.

The viewer may view the virtual image only from the position of the so-called eyebox. A region whose height and width correspond to a theoretical viewing window is referred to as an eyebox. As long as one of the viewer's eyes is within the eyebox, all elements of the virtual image are visible to that eye. If, on the other hand, the eye is outside the eyebox, the virtual image is only partially or not at all visible to the viewer. The larger the eyebox is, the less restricted the viewer is in choosing their seating position.

The size of the eyebox of conventional head-up displays is limited by the size of the optical unit. One approach for enlarging the eyebox is to couple the light coming from the picture generating unit into an optical waveguide. The light that is coupled into the optical waveguide undergoes total internal reflection at the interfaces of the latter and is thus guided within the optical waveguide. In addition, a portion of the light is coupled out at a multiplicity of positions along the propagation direction. Owing to the optical waveguide, the exit pupil is in this way expanded. The effective exit pupil is composed here of images of the aperture of the image generation system.

Against this background, US 2016/0124223 A1 describes a display apparatus for virtual images. The display apparatus comprises an optical waveguide that causes light that emanates from a picture generating unit and is incident through a first light incidence surface to repeatedly undergo total internal reflection in order to travel in a first direction away from the first light incidence surface. The optical waveguide also has the effect that a portion of the light guided in the optical waveguide emerges outward through regions of a first light exit surface which extends in the first direction. The display apparatus further comprises a first diffraction grating on the light-incidence side, which diffracts incident light so as to make the diffracted light enter the optical waveguide, and a first light-emergence diffraction grating, which diffracts light that is incident from the optical waveguide. US 2012/0224062 A1 also relates to a display apparatuses for virtual images with an optical waveguide.

In the currently known design of such a device in which the optical waveguide consists of glass plates within which diffraction gratings or holograms are arranged, a problem arises if light is incident from the outside. Stray light may enter the users eye due to reflections of the light that is incident from outside. The contrast of the virtual image perceived by the user is furthermore reduced.

In conventional devices, possibly reflective components are therefore tilted and combined with glare traps, so that reflections do not reach the region in which the driver's eye is expected to be. Alternatively, antireflection coatings are employed and structural roughnesses are used in order to reduce the reflection intensity.

The tilting of components significantly takes up installation space, which is limited in automobiles. Furthermore, the performance of the components is generally reduced with tilted installation. Layers and structures lessen the achievable intensity, but the reflections generally remain clearly visible and significantly reduce the contrast.

It is an object of the present disclosure to provide an improved device for generating a virtual image, with which the influence of stray light is reduced.

The background description provided herein is for the purpose of generally presenting the context of the disclosure. Work of the presently named inventors, to the extent it is described in this background section, as well as aspects of the description that may not otherwise qualify as prior art at the time of the filing, are neither expressly nor impliedly admitted as prior art against the present disclosure.

### SUMMARY

A device according to the disclosure for generating a virtual image has a display element for producing an image, an optical waveguide for expanding an exit pupil, and an anti-glare element which is arranged downstream of the optical waveguide in the beam path and is a shutter which has a plurality of slats whose setting angle is defined by at least one one-piece spring. The one-piece spring has a flexible mechanism. This allows freedom from hysteresis and backlash, which leads to an exact setting. In the solution according to the disclosure, the setting angle is independent of the temperature, since thermal expansion of the one-piece spring may change its overall length, but not its basic shape. Slats oriented at a slant of a defined angle maintain that angle even as the spring expands thermally. Provision is made for the slats to rest on slants of a defined angle and be movably suspended at their respective ends. As an alternative to this, at least two settable springs are provided, at whose slants of a defined angle the slats are fastened in their end regions.

According to the disclosure, the one-piece spring has a first plane and a second plane, which are connected to one another by transition slants. The transition slants represent a two-dimensional region of constant slant, and thus a large region on which slats come to rest. This enables an even more exact angle setting. According to the disclosure, the spring is punched from a thin two-dimensional material, which is folded after punching to form a three-dimensional component part by shifting the first plane and second plane, which originally lay in the same starting plane, perpendicularly to the starting plane so that they are thus spaced apart from one another and connected to one another by the transition slants.

According to the disclosure, at least two parallel rows of transition slants are provided, which are arranged offset from one another. This enables a denser arrangement of the slats. This leads to better shading of unwanted light.

The transition slant has in its transition region a perforation and/or a groove and/or a peripheral cutout to at least one of the first plane and the second plane. In this way, an increased effective elasticity is achieved in this transition region. This simplifies the forming from the two-dimensional shape to the three-dimensional shape when manufacturing the spring.

According to the disclosure, the transition regions of the one-piece spring have different lengths. As a result, different setting angles are achieved for different slats. This enables the formation of a setting angle gradient which is desirable in specific configurations of the device.

A plurality of springs are nested in one another or arranged next to one another. This enables the slats to be arranged more densely without the springs having to be made too filigree. The repetitions per unit length are thus multiplied.

### BRIEF DESCRIPTION OF THE DRAWINGS

Further features of the present disclosure will emerge from the following description and the appended claims in conjunction with the figures, wherein:

FIG. 1 schematically shows a head-up display according to the prior art for a motor vehicle;

FIG. 2 shows an optical waveguide with two-dimensional enlargement;

FIG. 3 schematically shows a head-up display with an optical waveguide;

FIG. 4 schematically shows a head-up display with an optical waveguide in a motor vehicle;

FIG. 5 schematically shows a head-up display with an optical waveguide and antireflection as an anti-glare element;

FIG. 6 shows an alternative optical waveguide with a two-dimensional enlargement;

FIG. 7 schematically shows a device according to the disclosure for generating a virtual image;

FIG. 8 shows a shutter and a detail enlargement thereof;

FIG. 9 shows a spring according to the disclosure;

FIG. 10 shows a spring according to the disclosure;

FIG. 11 shows a spring according to the disclosure in a side view;

FIG. 12 shows springs according to the disclosure in a side view;

FIG. 13 shows a spring in a side view with and without exertion of force;

FIG. 14 shows an anti-glare element in a top view, with and without the exertion of force;

FIG. 15 shows an anti-glare element in a schematic spatial view;

FIG. 16 shows a schematic spatial illustration of a spring according to the disclosure; and

FIG. 17 shows a spring in a side view with a setting angle gradient.

### DETAILED DESCRIPTION

For a better understanding of the principles of the present disclosure, embodiments of the disclosure will be explained in more detail below with reference to the figures. The same reference signs are used in the figures for identical or functionally identical elements and are not necessarily described again for each figure. It is to be understood that the disclosure is not limited to the illustrated embodiments and that the features described may also be combined or modified without departing from the scope of protection of the disclosure as it is defined in the appended claims.

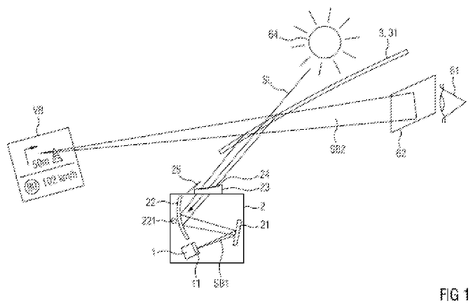

First, the basic concept of a head-up display with an optical waveguide will be explained with reference to FIGS. 1 to 4.

FIG. 1 shows a schematic diagram of a head-up display according to the prior art for a motor vehicle. The head-up display comprises an image generator 1, an optical unit 2, and a mirror unit 3. A beam of rays SB1 emanates from a display element 11 and is reflected by a folding mirror 21 onto a curved mirror 22, which reflects it in the direction of the mirror unit 3. The mirror unit 3 is represented here as a windshield 31 of a motor vehicle. From there, the beam of rays SB2 travels in the direction of an eye 61 of a viewer.

The viewer sees a virtual image VB that is located outside the motor vehicle, above the engine hood or even in front of the motor vehicle. Due to the interaction of the optical unit 2 and the mirror unit 3, the virtual image VB is an enlarged representation of the image displayed by the display element 11. A speed limit, the current vehicle speed, and navigation instructions are symbolically represented here. As long as the eye 61 is within the eyebox 62, which is indicated by a rectangle, all elements of the virtual image are visible to the eye 61. If the eye 61 is outside the eyebox 62, the virtual image VB is only partially or not at all visible to the viewer. The larger the eyebox 62 is, the less restricted the viewer is when choosing their seating position.

The curvature of the curved mirror 22 serves to condition the beam path and thus to ensure a larger image and a larger eyebox 62. In addition, the curvature compensates for a curvature of the windshield 31, with the result that the virtual image VB corresponds to an enlarged reproduction of the image represented by the display element 11. The curved mirror 22 is rotatably mounted by a bearing 221. The rotation of the curved mirror 22 that this allows makes it possible to displace the eyebox 62 and thus to adapt the position of the eyebox 62 to the position of the eye 61. The folding mirror 21 serves to ensure that the path traveled by the beam of rays SB1 between the display element 11 and the curved mirror 22 is long but, at the same time, that the optical unit 2 is nevertheless compact. The optical unit 2 is delimited from the environment by a transparent cover 23. The optical elements of the optical unit 2 are thus protected, for example, against dust located in the interior of the vehicle. Furthermore, an optical film 24 or a coating that is intended to prevent incoming sunlight SL from reaching the display element 11 via the mirrors 21, 22 is situated on the cover 23. Said display element 11 could otherwise be temporarily or permanently damaged by the resulting development of heat. In order to prevent this, for example, an infrared component of the sunlight SL is filtered out by the optical film 24 or at least in part reflected by it. Glare protection 25 serves to shade light incident from the front so that it is not reflected by the cover 23 in the direction of the windshield 31, which could cause the viewer to be dazzled. In addition to the sunlight SL, the light from another stray light source 64 might also reach the display element 11.

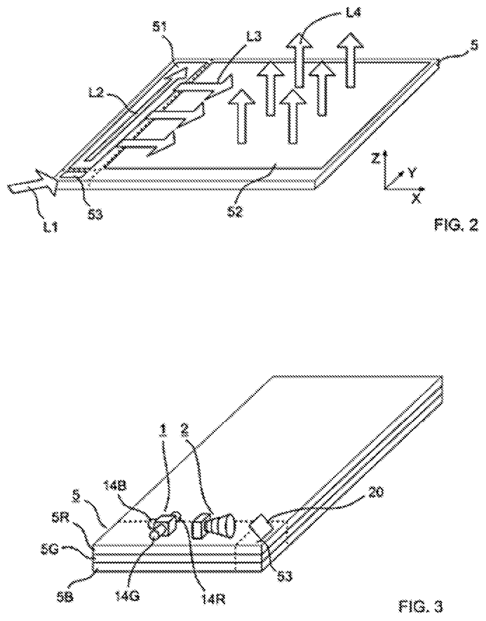

FIG. 2 shows a schematic spatial illustration of an optical waveguide 5 with two-dimensional enlargement. The lower left region shows an input coupling hologram 53, by which light L1 coming from a picture generating unit (not shown) is coupled into the optical waveguide 5. It propagates therein to the top right in the drawing, according to the arrow L2. In this region of the optical waveguide 5, there is a folding hologram 51 that acts similarly to many partially transmissive mirrors arranged one behind the other and produces a light beam that is broadened in the Y-direction and propagates in the X-direction. This is indicated by three arrows L3. In the part of the optical waveguide 5 that extends to the right in the figure, there is an output coupling hologram 52 that likewise acts similarly to many partially transmissive mirrors arranged one behind the other and couples out light, indicated by arrows L4, upwardly in the Z-direction out of the optical waveguide 5. In this case, broadening takes place in the X-direction, so that the original incident light beam L1 leaves the optical waveguide 5 as a light beam L4 that is enlarged in two dimensions.

FIG. 6 shows a schematic illustration of an optical waveguide with two-dimensional enlargement, which is an alternative to FIG. 2. Here, the output coupling hologram 52 is configured in such a way that it couples light out not perpendicularly to the surface of the optical waveguide 5 but at an angle with respect to the Z-direction, as illustrated by the arrows L4. In this way, the optical waveguide 5 may be arranged according to the available installation space, without having to allow for perpendicular emergence of the light beam enlarged in two dimensions.

FIG. 3 shows a spatial illustration of a head-up display with three optical waveguides 5R, 5G, 5B, which are arranged one above the other and each stand for an elementary color red, green, and blue. Together they form the optical waveguide 5. The holograms 51, 52, 53 present in the optical waveguide 5 are wavelength-dependent, so that one optical waveguide 5R, 5G, 5B is respectively used for one of the elementary colors. An image generator 1 and an optical unit 2 are illustrated above the optical waveguide 5. The optical unit 2 has a mirror 20, by which the light produced by the image generator 1 and shaped by the optical unit 2 is deflected in the direction of the respective input coupling hologram 53. The image generator 1 has three light sources 14R, 14G, 14B for the three elementary colors. It may be seen that the entire unit shown has a small overall height compared with its light-emitting surface.

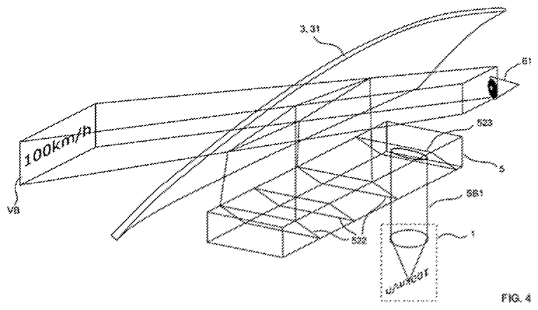

FIG. 4 shows a head-up display in a motor vehicle similar to FIG. 1, but here in a spatial illustration and with an optical waveguide 5. It shows the schematically indicated image generator 1, which produces a parallel beam of rays SB1 that is coupled into the optical waveguide 5 by means of the mirror plane 523. The optical unit is not illustrated for the sake of simplicity. A plurality of mirror planes 522 each reflect some of the light incident thereon in the direction of the windshield 31, the mirror unit 3. From here, the light is reflected in the direction of the eye 61. The viewer sees a virtual image VB above the engine hood or at an even farther distance in front of the motor vehicle.

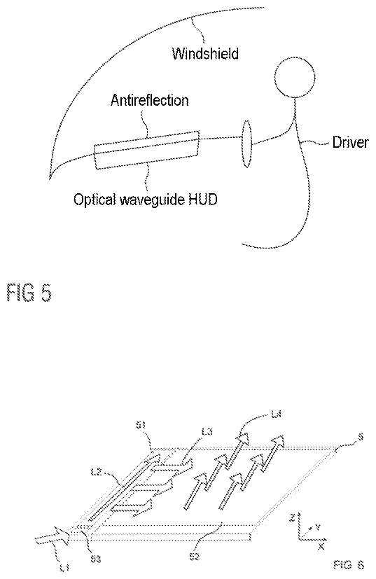

FIG. 5 schematically shows a head-up display with an optical waveguide and antireflection as an anti-glare element.

FIG. 7 shows a device according to the disclosure, in which an optical waveguide 5 is used in a manner corresponding to FIG. 6. It shows the image generator 1 with a display element 11 and the optical waveguide 5, from which light L4 emerges at an angle α with respect to the normal N to the light exit surface 54 of the optical waveguide 5, with the angle α being greater than 0°. The emerging light L4 is incident on the light entry surface 85 of the shutter 83, the slats 82 of which are parallel to the emerging light L4, so that it may pass unimpeded through the intermediate spaces 84 between the slats 82. The light L6 emerging from the shutter 83 is incident on the windshield 31 at an angle β and is reflected thereby, and enters the eye 61 of a vehicle occupant, here the driver, as light L8. The driver therefore sees a virtual image VB. In this embodiment, the shutter 83 forms the cover for the optical unit, and any separate cover element that may be present must be moved away during operation. The shutter 83 may therefore also come in direct contact with objects or persons located in the interior of the vehicle. Damage to the shutter 83 is therefore not precluded. The shutter 83 is therefore preferably arranged releasably so that, if need be, it is removed without much effort and replaceable with a new or repaired shutter 83.

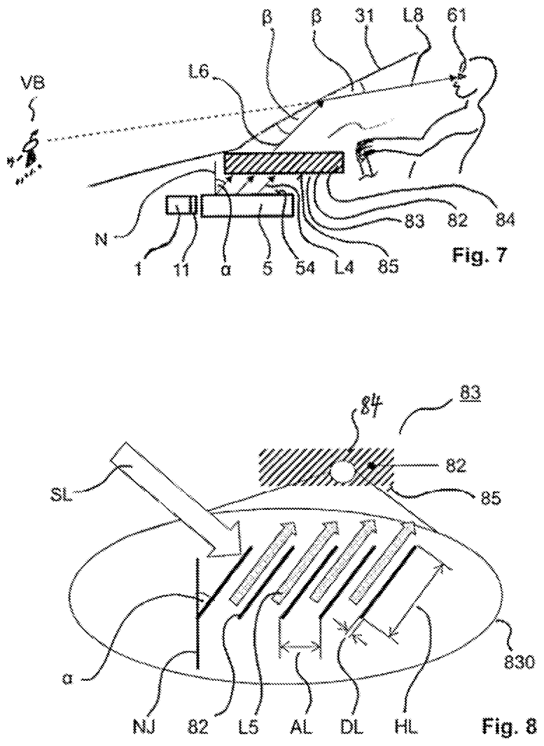

FIG. 8 shows the shutter 83 and a detail enlargement 830. It shows the slats 82, which let through light L5 that emanates from the optical waveguide 5 and travels substantially parallel to the slats 82. Stray light SL that does not travel parallel to the slats 82 is blocked by the slats 82. The slats 82 have a mutual spacing AL and are inclined by an angle α with respect to the normal NJ to the light entry surface 85 of the shutter 83. The slats have a height HL and a thickness DL, wherein the height HL is a multiple of the thickness DL. The angle α corresponds to that of the light emergence from the optical waveguide 5 when the light exit surface 54 of the latter and the light entry surface 85 of the shutter 83 are arranged parallel to one another. In the case of a non-parallel arrangement, these angles are to be converted accordingly. The angle α depends, inter alia, on the position of the driver and their angle of view. For different types of vehicle or different inclinations of the windshield 31, inter alia the distance AL needs to be adapted. The slats 82 are for example configured to be non-reflective, that is to say substantially black. If the slats are arranged so as to be tiltable, that is to say the angle α is variably settable during operation, they may be set to different positions of the eyebox, or to different positions of the eye 61 inside the eyebox. This assumes that the light emanating from the optical waveguide 5 covers a specific angle range so that, for each set angle α, light rays that are aligned parallel to the slats arrive on the latter and therefore pass through them.

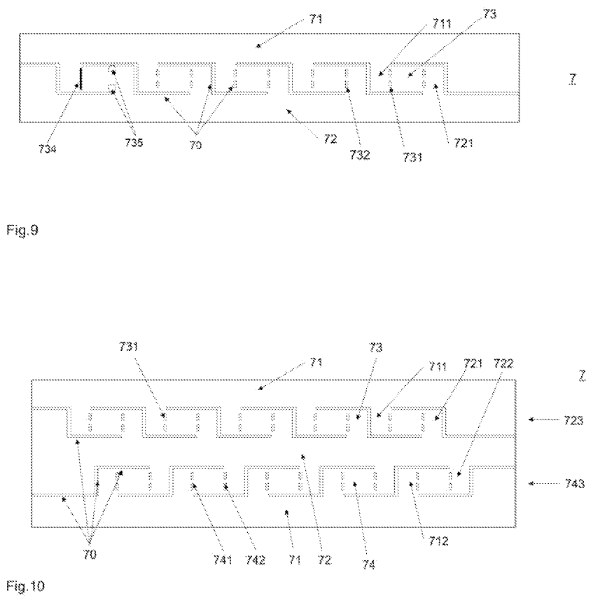

FIG. 9 shows a spring 7 according to the disclosure in a top view. The spring 7 is shown here in its two-dimensional form, which it has before it is brought into its three-dimensional form during manufacturing. The figure shows the first plane 71 and the second plane 72, which in the two-dimensional form are both still in the same plane, here the plane of the drawing. Bars 711 extend from the first plane 71 in the direction of the second plane 72. Bars 721 extend from the second plane 72 in the direction of the first plane 71. Transition slants 73 connect in each case one bar 711 to a bar 721. A perforation 731 is arranged at the transition between a bar 711 of the first plane 71 and the transition slant 73. A perforation 732 is arranged at the transition between a bar 721 of the second plane 72 and the transition slant 73. A kink forms at this perforation 731, 732 when the spring 7 is moved from its illustrated two-dimensional shape to its 3-dimensional shape. The transition slant 73 is then at an angle to the planes 71, 72 and forms a substantially planar surface between the perforations 731, 732. To produce the spring 7, a thin, rectangular metal sheet or a corresponding foil is preferably used, which is cut, punched or processed in some other suitable manner using a cutting contour 70. In the left part of the figure, a groove 734 is shown as an example, which is provided either instead of the perforation 731 or in addition to it. Peripheral cutouts 735 are likewise shown, as an alternative to the perforation 731. It goes without saying that normally only either perforations 731 or grooves 734 or peripheral cutouts 735 are provided in a spring 7. However, a combination of two or three of these elements may also be a useful configuration of the invention.

FIG. 10 shows a spring 7 according to the invention, in which there are transition slants 73, 74 offset from one another. As shown in FIG. 9, the transition slants 73 are connected to the part of the first plane 71 shown in the upper region of the figure by means of the bars 711 and to the second plane 72 shown in the middle region of the figure by means of the bars 721. Bars 712 are shown in the lower region of the figure, which are arranged offset from the bars 711 and extend from the region of the first plane 71 shown in the lower region of the figure in the direction of the second plane 72. Correspondingly offset bars 722 extend from the region of the plane 71 shown in the lower region of the figure in the direction of the plane 72. The transition slants 74 are arranged between the bars 712, 722. Perforations 741, 742 are correspondingly provided as previously described. The cutting contours are as described for FIG. 9. When the spring 7 is folded from the two-dimensional shape into the three-dimensional shape, the transition slants 73, 74 form parallel planes that are offset from one another. The transition slants 73 form a row 733 and the transition slants 74 form a row 734, which are parallel to one another.

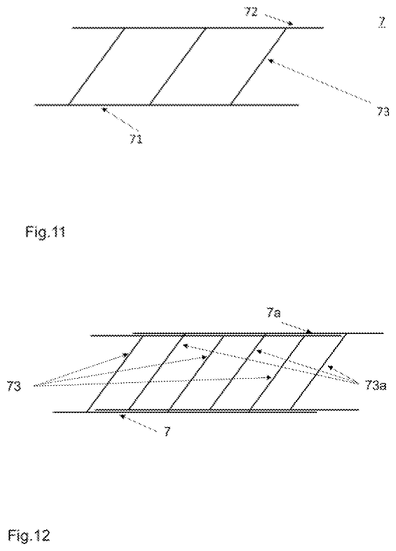

FIG. 11 shows a spring 7 according to the disclosure in its three-dimensional form in a side view. It shows the planes 71, 72, which are spaced apart from one another in this form and which are connected to one another by the transition slants 73. The transition slants 73 are arranged at an angle and are parallel to one another in the illustrated embodiment.

FIG. 12 shows two springs 7, 7a according to the disclosure in a side view. The springs 7, 7a are offset from each other so that their respective springs 73, 73a are arranged alternately to each other. A denser succession of slats 82 is achieved by these springs 7, 7a, which are inserted into one another, for example, thus improving shading.

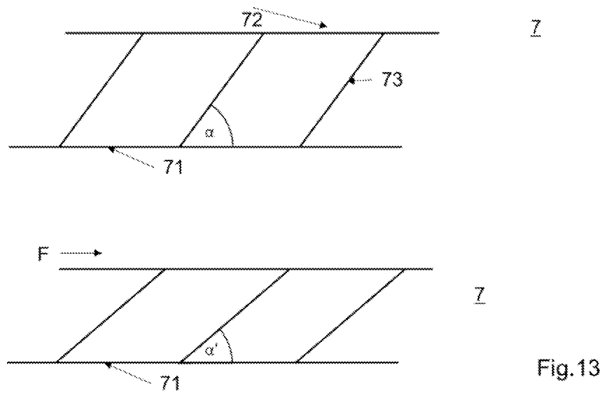

FIG. 13 shows a spring 7 in a side view, above without the exertion of force on the planes 71, 72, and below with the exertion of force on the planes 71, 72. It may be seen that the transition slants 73 in the upper part of the figure, i.e. in their original state, have a different setting angle α than in the lower part of the figure, in which the setting angle α′ is smaller. This is achieved by exerting a force F on one of the two planes 71, 72 while the other is mechanically fixed, or by forces acting on both planes 71, 72 but in opposite directions. The force F can be introduced parallel, perpendicular, or at an angle to the plane 71, 72.

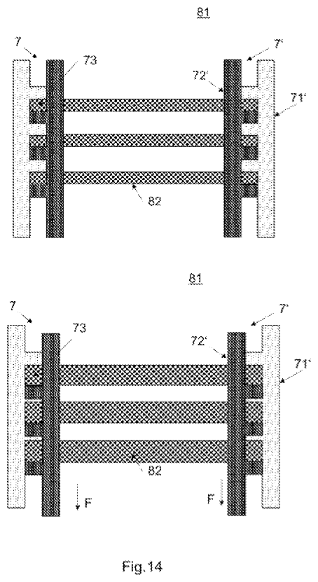

FIG. 14 shows an anti-glare element 81 in a top view, in the lower part of the figure with a force being exerted and in the upper part of the figure without a force being exerted. The anti-glare element 81 has a spring 7 on the left and a spring 7′ on the right. As described above, these have first planes 71, 71′ and second planes 72, 72′. Slats 82 are clamped between the springs 7, 7′. In the embodiment shown, the slats 82 are fastened at their ends to the transition slants 73, which are therefore not visible in the figure. It may be seen in the upper region of the figure that the planes 71, 71′ and 72, 72′ are not shifted relative to one another. In the lower region of the figure, a force F acts on the planes 72, 72′, as a result of which they are shifted in relation to the first planes 71, 71′. The transition slants 73 change their angle and thus do the slats 82.

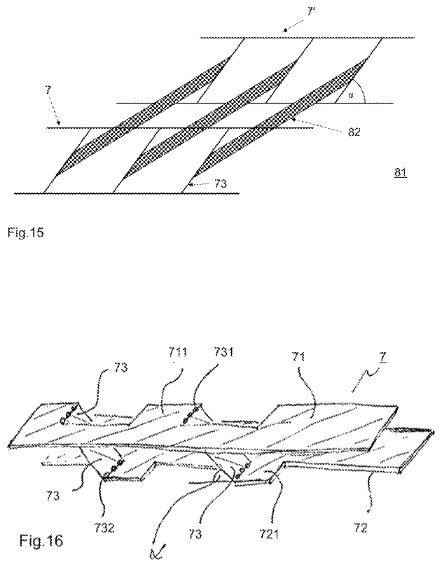

FIG. 15 shows an anti-glare element 81 in a schematic spatial view. Two springs 7, 7′, stylized only by lines, can be seen with their transition slants 73, to which the slats 82 are fastened. The setting angle α is also shown.

FIG. 16 shows a schematic spatial illustration of a spring 7 according to the disclosure in its three-dimensional form. It shows the spatially separated planes 71, 72. The first plane 71 is located above the second plane 72. The transition slants 73 run at an angle from top left to bottom right. They are connected at the top to the bars 711, at their lower ends to the bars 721. There is a perforation 731 in the transition region between bar 711, 721 and transition region 73. If the upper plane 71 is shifted to the left by the exertion of a force, the setting angle α becomes smaller, the inclination of the transition slant 73 is less pronounced and so is the inclination of the respective slat (not shown here) in contact with it. If the upper plane 71 is shifted to the right by the exertion of a force, the setting angle α becomes larger, the transition slants 73 are steeper and so too the corresponding slats. The one-piece design of the spring 7 ensures that the transition slants 73 are always parallel to one another in this case, i.e. have the same setting angle α.

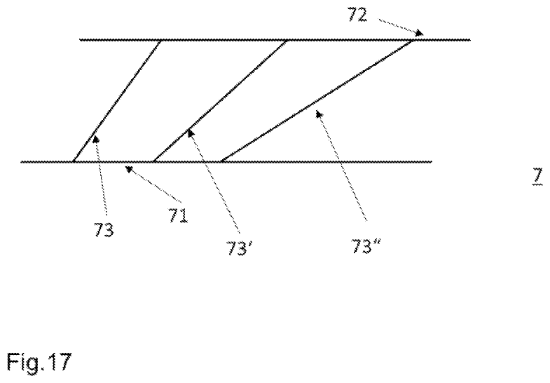

FIG. 17 shows a variant of a spring 7 according to the disclosure in a side view. This variant has transition slants 73, 73′, 73″ with different setting angles. This is accomplished by the different lengths of the transition slants 73, 73′, 73″, which are shown here in an exaggerated manner for the sake of clarity. In the variant shown, a setting angle gradient is achieved. Depending on the extent to which the lengths of the transition slants 73, 73′, 73″ differ from one another, provision is made for the planes 71, 72 to be designed to be flexible. Alternatively, provision is made for a plurality of suitably arranged perforations 731, corresponding grooves 734 or peripheral cutouts 735 to be located in the transition region between the bar 711, 721 and the transition slant 73, which ensure increased flexibility in this region, and then allow different setting angles α, α′, α″.

In other words, the disclosure relates to the following: In head-up displays, antireflection is achieved using a glare trap with a curved foil. This design has a minimum installation depth corresponding to the foil curvature. Antireflection of head-up displays which use the windshield as a mirror element or projection surface is realized by slats or a grid structure as a terminating assembly, see for example FIG. 5. An antireflection solution is needed in particular for head-up displays with optical waveguides in flat installation, since flat glass components directly below the windshield are particularly susceptible to disturbing reflections. This solution is for example angle-adjustable in order to reduce shading in the eyebox. Slats clamped in a frame are for example provided for antireflection.

According to the disclosure, different setting angles of the slats are made possible for different eyebox positions. This helps to avoid undesired shading. The disclosure proposes a secured solution for allowing the angle adjustment of the slats.

According to the disclosure, a uniform angle adjustment of all the slats in the component part is achieved. Only a single element is required for the angle adjustment. It is therefore not necessary to adjust or control each individual slat.

The disclosure relates to a resilient spring mechanism for an angle-adjustable antireflection device, the anti-glare element 81. Currently, only antireflection means or visual protection methods with a fixed angle, mostly perpendicular to the surface, are known for imaging methods such as those used for telescopes, projectors or monitors. These are, for example, a visual protection film for cell phones, an antireflection device for telescopes or the like. Solutions with a roughly adjustable transmission angle, for example shutters for windows, are also known. These non-adjustable methods do not allow the system to adapt to the viewer. Viewing angle and angle range for visual/reflection protection are the same or dependent on one another. For applications that are intended to allow only a particularly narrow light incidence angle, but are intended at the same time to allow a larger viewing/transmission angle range and a high transmittance, a very fine setting of the transmission angle and very little coverage in the transmission region is necessary. A dependence on external influences, such as temperature or humidity, on the setting angle should be as small as possible.

According to the disclosure, the slats 82 are implemented with a resilient mechanism based on a three-dimensionally shaped spring 7 outside of the visible region. The spring 7 is cut from a piece of foil or sheet metal. Cutting patterns are shown in FIG. 9 (single version) and FIG. 10 (double version with offset). The first plane 71, and also all other planes, forms an ideally contiguous region. Each plane 71, 72 is connected to the next plane via bars 711, 712, 721, 722 in the respective plane via transition slants 73, 73′, 73″, 74. Perforations 741, 742 may be used between bars 711, 712, 721, 722 and transition slants 73, 73′, 73″, 74 in order to increase the effective elasticity in the region.

The sheet metal/foil is then bent in two or more planes. FIG. 11 shows the result in a side view. The adjustment angle depends on the pattern and can therefore be defined individually for each slat 82. In this way, an adjustment angle gradient may be achieved over the emission surface of the head-up display. The number of planes and the offset may be changed and increased as desired. A plurality of springs 7, 7a can be inserted into one another or attached next to or one above the other in order to double or multiply the number of repetition units per unit length, see FIG. 12. If either a plane is fixed and the respectively next plane is subjected to a force along the plane, or if both planes are subjected to opposite shear or tension, the angle of the slats 82 changes, see FIG. 13.

The springs 7 themselves are located on the product outside of the optical functional region, see FIG. 14. According to one embodiment, the slats 82 are attached to the transition regions, see FIG. 15.

In a further embodiment variant, the slats 82 are adjusted by contact with the transition slants 73 only in terms of the angle and fastened in some other way. In one embodiment variant, the transition slants 73 may correspond approximately to the height of the slat 82 or be made significantly longer. If the transition slants 73 are significantly larger than the slats 82, a trough is arranged in the transition slants 73 in order to simplify the positioning of the slats 82 during assembly.

The changed slat setting angle changes the effective coverage of the beam path, see FIG. 14. The connected strips in the different planes are additionally connected with reinforcements.

The solution according to the disclosure allows a hysteresis-free and backlash-free setting of the setting angle for the slats 82 of the “shutters.” The area coverage in the transmission region is minimal, so as much light as possible reaches the eye 62 from the desired source, while as much interfering light as possible is prevented from reaching the eye 62 of the viewer. In the solution according to the invention, the setting angle is, in principle, independent of temperature.

The solution according to the disclosure may also be employed in conventional head-up displays (for example based on mirrors). Here, the anti-glare element is preferably used as a terminating assembly. The solution according to the disclosure may also be used as adjustable antireflection inside modules. The anti-glare element is then integrated into the assembly. The solution according to the disclosure may also be used as visual protection for displays (privacy filter) as an adaptive solution. The solution according to the disclosure may also be used as visual protection for windows/domelight windows (smartwindows) for brightness setting. The disclosure may also be used in the aerospace sector, for example for glare protection in optical measuring instruments or for the precise spatial resolution of radiation sources.

1. A device for generating a virtual image, comprising:
a display element for generating an image;
an optical waveguide for expanding an exit pupil; and
an anti-glare element arranged downstream of the optical waveguide in the beam path, wherein
the anti-glare element is a shutter which has a plurality of slats, wherein the slats come to rest in each case on a transition slant of at least one one-piece spring.

2. The device as claimed in claim 1, wherein the one-piece spring has a first plane and a second plane, which are connected to one another by transition slants.

3. The device as claimed in claim 2, having at least two parallel rows of transition slants which are arranged offset from one another.

4. The device as claimed in claim 1,
wherein the transition slant in its transition region to at least one of the first plane and the second plane has a perforation, groove or peripheral cutout.

5. The device as claimed in claim 1, wherein the transition slants of the one-piece spring have different lengths.

6. The device as claimed in claim 1, wherein a plurality of springs are nested in one another or arranged next to one another.

7. The device as claimed in claim 1, wherein the slats have a variably settable setting angle.
